(19) United States
(12) Patent Application Publication
(10) Pub. No.: US 2005/0198899 A1
(43) Pub. Date: Sep. 15, 2005

(54) System and process for producing a reformate

(75) Inventors: Norbert Gunther, Ribnitz-Damgarten (DE); Stefan Kading, Zerrenthin (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 11/014,242

(22) Filed: Dec. 17, 2004

(30) Foreign Application Priority Data
Dec. 17, 2003 (DE) 103 59 231.8

(51) Int. Cl. C01B 3/32

(52) U.S. Cl. 48/198.7; 48/197 R; 48/127.9

(57) ABSTRACT

System and process for producing a reformate to be supplied to a fuel cell stack, the system having a reformer (12) to which fuel (14), air (16) and the anode exhaust gas (18) of the fuel cell stack can be supplied to produce the reformate (10). The system has one or more devices (20) which at least partially oxidize the anode exhaust gas (18) before it is supplied to the reformer (12).

### BACKGROUND OF THE INVENTION

1. Filed of Invention

The invention relates to a system for producing a reformate which is intended to be supplied to a fuel cell stack, the system having a reformer to which fuel, air and the anode exhaust gas of the fuel cell stack can be supplied to produce the reformate. Furthermore, the invention also relates to a process for producing a reformate which is intended to be supplied to a fuel cell stack, the reformate being produced in a reformer to which fuel, air and the anode exhaust gas of the fuel cell stack are supplied to produce the reformate.

2. Description of Related Art

Systems and processes of the type to which the invention is directed are used in conjunction with the conversion of chemical energy into electrical energy. For this purpose, fuel and air, preferably in the form of a fuel/air mixture, are supplied to the reformer. The reaction of the fuel with atmospheric oxygen takes place in the reformer, preferably the process of partial oxidation being carried out.

The reformate which has been produced in this way is then supplied to a fuel cell or a fuel cell stack, electrical energy being released by controlled reaction of hydrogen as a component of the reformate, and oxygen. It is known to supply anode exhaust gas of the fuel cell stack to the reformer to increase efficiency, and in addition, to at least partially recover the water contained in the anode exhaust gas and the hydrogen contained in the anode exhaust gas is known.

As already mentioned, the reformer can be designed such that the process of partial oxidation is carried out in order to produce reformate. In this case, when using diesel as fuel, it is especially useful to carry out preliminary reactions before partial oxidation. In this way, long-chain diesel molecules can be reacted into shorter-chain molecules with a “cold flame;” this ultimately benefits reformer operation. In general, the reaction zone of the reformer is supplied with a gas mixture which is reacted into H₂ and CO. Another component of the reformate is N₂ from the air, and depending on the air ratio and the temperature, optionally, CO₂, H₂O and CH₄. In normal operation, the fuel mass flow is adjusted according to the required output, and the air mass flow is adjusted to a lambda value or an air ratio in the region of λ=0.4. The reforming reaction can be monitored by different sensors, for example, temperature sensors and gas sensors.

In addition to the process of partial oxidation, it is likewise possible to carry out autothermal reforming. The process of partial oxidation, in contrast to autothermal reforming, is induced by oxygen being substoichiometrically supplied. For example, the mixture has an air ratio of μ=0.4. The partial oxidation is exothermal, so that unwanted heating of the reformer can occur in a problematic manner. Furthermore, partial oxidation tends to increased soot formation. To prevent soot formation, the air ratio λ can be made to be greater than and/or a part of the oxygen which is used for oxidation by water vapor. Since oxidation proceeds endothermally with water vapor, it is possible to adjust the ratio between the fuel, oxygen and water vapor such that, altogether, heat is neither released nor is heat consumed. Autothermal reforming which is achieved in this way, therefore, eliminates the problems of soot formation and undesirable overheating of the reformer.

It is likewise possible for other steps of gas treatment to take place following oxidation in the reformer, and especially methanation can be downstream of partial oxidation.

One current fuel cell system is, for example, a PEM (proton exchange membrane) system which can typically be operated at operating temperatures between room temperature and roughly 100° C. Due to the low operating temperatures, this fuel cell type is often used for mobile applications, for example, in motor vehicles.

Furthermore, high temperature fuel cells are known, so-called SOFC systems (“solid oxide fuel cell”). These systems work for example in the temperature region of roughly 800° C., a solid electrolyte (solid oxide) being able to take over transport of oxygen ions. The advantage of these high temperature fuel cells compared to PEM systems consists especially in durability relative to mechanical and chemical loads.

Besides stationary applications, one application for fuel cells in conjunction with the prior systems includes especially applications in the motor vehicle domain, for example, as an auxiliary power unit (APU).

### SUMMARY OF THE INVENTION

A primary object of the invention is to develop the prior systems and processes such that reforming efficiency is further improved.

This object is achieved by the provision of a means for at least partially oxidizing the anode exhaust gas before supply to the reformer

The system in accordance with the invention is based on the generic prior art in that it has means which are suited for at least partially oxidizing the anode exhaust gas before it is supplied to the reformer. The at least partial oxidation of the anode exhaust gas increases the amount of water which is delivered into the reformer, by which the reforming efficiency is distinctly improved.

In preferred embodiments of the system of the invention, it is provided that the means comprise an ignition source and/or a catalyst. Moreover, the means comprise preferably a reaction chamber in which at least partial oxidation takes place.

One preferred development of the system in accordance with the invention calls for the means to be able to carry out at least partial oxidation with the air which is intended for producing the reformate. However, this does not preclude additional fresh air from being supplied to the reformer, if necessary. The means intended according to the invention for executing the at least partial oxidation can be assigned in all embodiments either to the reformer or can form a component of it, or it can be provided separately at some suitable location of the system.

In conjunction with the system of the invention, it is considered especially advantageous that the reformer has a reaction space to which the fuel, the at least partially oxidized anode exhaust gas and the residual air remaining after at least partial oxidation can be supplied. In this way, the oxidized anode exhaust gas and the remaining residual air can, if necessary, be preheated by oxidation prior to being introduced into the reaction space; this has a very advantageous effect on reforming in many cases.

The process of the invention is based on the generic prior art in that the anode exhaust gas is at least partially oxidized before supply to the reformer. This results in the advantages and properties explained in conjunction with the system in accordance with the invention in the same or similar manner, for which reason to prevent repetitions reference is made to the corresponding statements in conjunction with the system of the invention.

The same applies analogously to the following preferred embodiments of the process of the invention, to avoid repetitions reference being made to the corresponding statements in conjunction with the system as claimed in the invention.

In one preferred embodiment of the process in accordance with the invention, it is provided that the at least partial oxidation is carried out using an ignition source and/or a catalyst.

Furthermore, it is considered advantageous to the process of the invention that the at least partial oxidation is carried out with the air which is intended to produce the reformate.

It is also preferred for the process according to the invention that the reformate is produced in a reaction space to which the fuel, the at least partially oxidized anode exhaust gas and the residual air remaining after at least partial oxidation is supplied.

The important basic idea of the invention is that the reforming efficiency can be greatly improved when the at least partially oxidized anode exhaust gas is supplied to the reforming process.

Preferred embodiments of the invention are explained by way of example below with reference to the accompanying drawings.

### BRIEF DESCRIPTION OF THE DRAWINGS

FIG. 1 is a schematic block diagram which illustrates one embodiment of the system in accordance with the invention; and

FIG. 2 is a flow chart which illustrates one embodiment of the process of the invention.

### DETAILED DESCRIPTION OF THE INVENTION

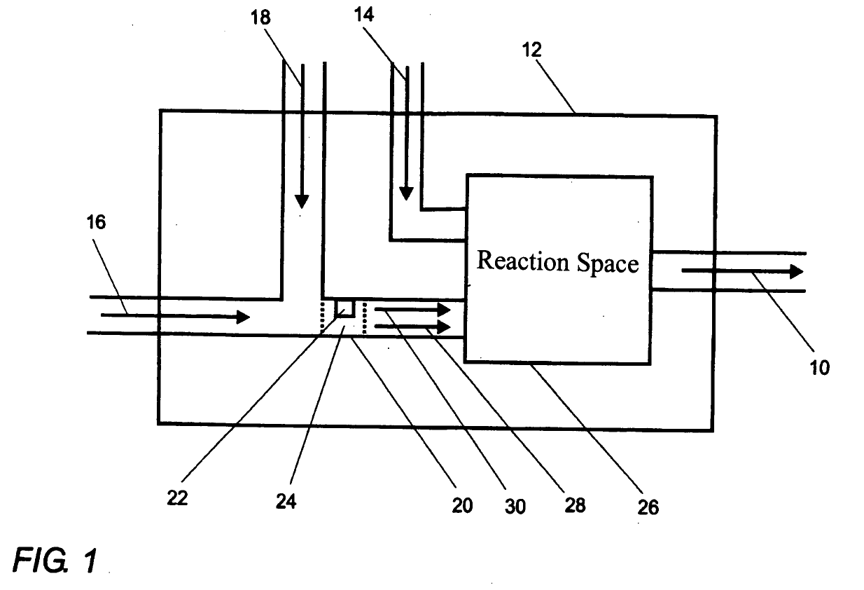

The system shown in the block diagram in FIG. 1 comprises a reformer 12 to which, via suitable lines or channels, fuel 14, air 16 and anode exhaust gas 18 are supplied, the anode exhaust gas 18 originating from a fuel cell stack (not shown) and which is supplied with reformate 10 from the reformer 12. The air 16 and the anode exhaust gas 18 are supplied to means 20 in the form of a reaction chamber where at least partial oxidation of the anode exhaust gas 18 takes place. The means 20 or the reaction chamber can optionally comprise a schematically shown ignition source 22 and/or a catalyst 24. The reformer 12 has a reaction space 26 in which the reformate 10 is produced. The reaction space 26 is supplied with the fuel 14, the at least partially oxidized anode exhaust gas 28 and the residual air 30 remaining after at least partial oxidation. In this way, the amount of water which has been delivered into the reaction space 26 is increased, by which the reforming efficiency is improved.

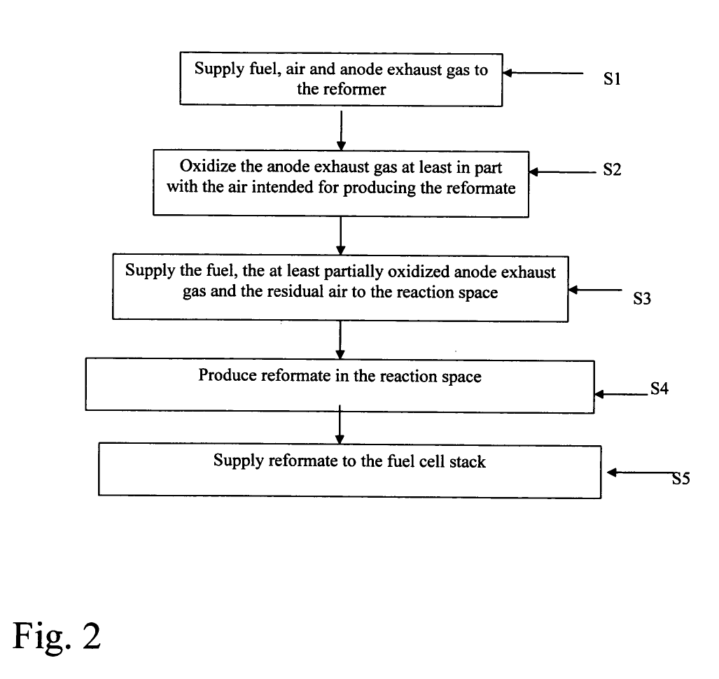

The flow chart shown in FIG. 2 illustrates one embodiment of the process as claimed in the invention, and this process can be carried out advantageously with the system from FIG. 1.

In step S1, fuel, air and anode exhaust gas are supplied to the reformer.

Then, in step S2, the anode exhaust gas is at least partially oxidized with the air which is intended for producing the reformate.

In step S3, the fuel, the at least partially oxidized anode exhaust gas and the residual air are supplied to the reaction space.

Then, the reformate is produced in step S4.

Finally, the reformate produced in step S4 is supplied to the fuel cell stack in step S5.

The features of the invention which are disclosed in the description above, in the drawings and in the claims can be significant to the implementation of the invention both individually and also in any combination.

1. System for producing a reformate for delivery to a fuel cell stack, comprising:
a reformer having intake lines for receiving fuel, air and anode exhaust gas of a fuel cell stack and adapted for producing reformate, and
oxidizing means for at least partially oxidizing the anode exhaust gas before delivery there of to the reformer.

2. System as claimed in claim 1, wherein the oxidizing means comprise at least one of an ignition source and a catalyst.

3. System as claimed in claim 2, wherein the oxidizing means is adapted for carrying out at least partial oxidation with air for producing the reformate.

4. System as claimed in claim 1, wherein the oxidizing means is adapted for carrying out at least partial oxidation with air for producing the reformate.

5. System as claimed in claim 1, wherein the reformer has a reaction space to which the fuel, the at least partially oxidized anode exhaust gas and residual air remaining after at least partial oxidation are supplied.

6. Process for producing a reformate for delivery to a fuel cell stack, comprising the steps of:
supplying fuel, air and anode exhaust gas of a fuel cell stack to a reformer, and
producing the reformate in a reformer,
wherein the anode exhaust gas is at least partially oxidized before being supplied to the reformer.

7. Process as claimed in claim 6, wherein the at least partial oxidation is carried out using at least one of an ignition source and a catalyst.

8. Process as claimed in claim 7, wherein the at least partial oxidation is carried out with air for producing the reformate.

9. Process as claimed in claim 8, wherein the reformate is produced in a reaction space to which the fuel, the at least partially oxidized anode exhaust gas and residual air remaining after at least partial oxidation are supplied.

10. Process as claimed in claim 6, wherein the at least partial oxidation is carried out with air for producing the reformate.

11. Process as claimed in claim 10, wherein the reformate is produced in a reaction space to which the fuel, the at least partially oxidized anode exhaust gas and residual air remaining after at least partial oxidation are supplied.

12. Process as claimed in claim 6, wherein the reformate is produced in a reaction space to which the fuel, the at least partially oxidized anode exhaust gas and residual air remaining after at least partial oxidation are supplied.
